(19) United States
(12) Patent Application Publication
(10) Pub. No.: US 2012/0316902 A1
(43) Pub. Date: Dec. 13, 2012

(54) USER INTERFACE FOR REAL TIME VIEW OF WEB SITE ACTIVITY

(76) Inventors: Amit Kumar, San Jose, CA (US); Frank Cezar Ramirez, San Jose, CA (US); Kent Brewster, East Palo Alto, CA (US)

(21) Appl. No.: 13/474,555

(22) Filed: May 17, 2012

Related U.S. Application Data
(60) Provisional application No. 61/487,237, filed on May 17, 2011.

(51) Int. Cl. G06Q 10/00; G06Q 30/00

(52) U.S. Cl. 705/7.11

(57) ABSTRACT

A user interface (UI) adapted to allow a Web site owner/operator to view real time information concerning activities of visitors to a Web site. The UI includes a plurality of information fields that provide real time information concerning visitor browsing and purchasing activities at the subject Web site with which the analytics information is concerned. The information is organized as some or all of: visitor purchasing behavior as grouped by proximity to completing a purchase, visitor visit history, product-based visitor viewing history, visitor referral path, visitor keyword search history, visitor click path, and/or visitor location.

### FIELD OF THE INVENTION

This application is a NONPROVISIONAL of, claims priority to and incorporates by reference U.S. Provisional Application No. 61/487,237, filed 17 May 2011.

### FIELD OF THE INVENTION

The present invention relates generally to the field of Web analytics and, in particular, to a user interface adapted to allow a Web site owner/operator to view real time information concerning activities of visitors to the Web site.

### BACKGROUND

The Internet is a vast and expanding network of computers and other devices linked together by various telecommunications media, enabling those computers and other devices to exchange and share data. A computer or resource that is attached to the Internet is often referred to as a host. In most cases, hosts are embodied as hardware and/or software components of a server or other computer system that includes an interface module, which allows for some dialog with a client; that is, a computer system operated by a user seeking information from the server host. Such information is usually accessed by the client via appropriate software applications. For example, Web sites hosted by server hosts are typically accessed via Web browsers running on clients.

Web sites come in a variety of forms and usually include a collection of Web pages. These “pages” are not truly pages in the sense that a book has pages; rather, they are computer-executable instructions that instruct a Web browser how to render or display information such as text, images, graphical elements, etc., and, in some cases, specify the identity of hosts where various items of the information that makes up the Web page can be found. The Web browser collects the various information comprising the page and displays it at the client in the manner instructed in order to present the “page” to the user. Users then navigate on and between the Web pages using cursor control actions such as movements and selection operations (e.g., clicks).

Many Web sites are devoted to commercial activities. For example, virtual stores such as Amazon™ have sophisticated Web sites that offer a wide variety of products for sale to consumers. Other Web sites provide more limited sets of specialty items and still others cater to business customers as opposed to general consumers. Some Web-based stores have physical world counterparts, but many do not. Irrespective of whether the Web-based stores sell to consumers or business or whether they are extensions of physical world stores or not, virtually all Web-based store owners have an interest in understanding who is visiting their Web site and what activities those visitors are engaged in during such visits.

This need for information regarding Web site visitors has spawned the industry of Web analytics. Broadly speaking, Web analytics may be regarded as the measurement, collection, analysis and reporting of data for purposes of understanding Web site usage. Such analytics are also used in connection with business and market research. Many Web hosting providers, such as Google™, Yahoo!™ and others, offer this kind of analytical information to their subscribers in connection with sites hosted for those subscribers. In particular, on-site Web analytics provide a Web site owner/operator with information regarding actual Web site visitor activities, but usually this is provided in the form of a compilation of historical information over various time periods/visits. While somewhat useful, historical information provides only an after-the-fact view of visitor behaviors and has limited benefit for the Web site owner/operator.

### SUMMARY OF THE INVENTION

In one embodiment of the invention, a user interface (UI) adapted to allow a Web site owner/operator to view real time information concerning activities of visitors to the Web site is provided. Such a UI may be presented by a server or other computer system, and may include analytics information concerning activities at a subject web site. The UI may include a plurality of information fields which provide real time information concerning visitor browsing and purchasing activities at the subject Web site with which the analytics information is concerned. The information may be organized as some or all of: visitor purchasing behavior as grouped by proximity to completing a purchase, visitor visit history, product-based visitor viewing history, visitor referral path, visitor keyword search history, visitor click path, and/or visitor location.

Further details concerning and embodiments of the present invention are discussed in greater detail below.

### BRIEF DESCRIPTION OF THE DRAWINGS

The present invention will be more fully understood from the following detailed description thereof, taken together with the accompanying drawings, in which:

FIG. 1 illustrates components of a network in which embodiments of the present invention may be implemented;

FIGS. 2 and 3 are examples of computer architectures for computer systems configured in accordance with embodiments of the present invention; and

FIGS. 4-8 illustrate examples of user interfaces for real time web analytics information in accordance with various embodiments of the present invention.

### DETAILED DESCRIPTION

The present inventors have recognized that historical Web analytic information does not afford a Web site owner/operator opportunities for direct and meaningful interaction with visitors to the Web site. For example, reliance on only historical information does not afford the owner/operator a chance to influence a purchase decision of a Web site visitor in real time. Nor does the historical information permit an owner/operator opportunities to provide valued clients of the Web site specialized services or personalized attention during a current visit to the Web site. Accordingly, the present inventors have recognized a need for providing real time Web analytics to owners/operators of Web sites, especially those Web sites devoted to commercial activities, and have developed a user interface (UI) adapted to allow a Web site owner/operator to view real time information concerning activities of visitors to the Web site.

In various embodiments, the UI for viewing real time information concerning activities of visitors to a Web site can be presented as a Web page to a Web site owner/operator (hereafter the term Web site administrator will be used to encompass owners, operators, administrators, and others responsible for the operation, maintenance and provision of a Web site) at a client computer. The UI provides a “live view” of the activities of one or more visitors to the subject Web site (or sites), allowing the Web site administrator opportunities to influence purchase decisions or actions of the Web site visitors, provide personalized services or attention to various ones of those visitors, and to better comprehend actual site visitor behaviors. Various forms of UIs configured in accordance with the present invention may include graphical and other representations of site visitors, characterized by activity, by Web page, by product or service, by location, by referring source, by referring mechanism (e.g., search keywords which resulted in a visitor obtaining a link to the subject Web site from a search engine), and/or by other attributes.

In one particular instantiation, the present UI may include a an animated floor plan in which a virtual store is represented by a virtual floor plan with products offered by the store arranged in virtual departments or shelves, and visitors to the Web site are represented as graphical icons or other representations within the virtual store floor plan. As the visitors browse from page to page or product to product, their associated icons can be moved to corresponding positions within the virtual floor plan to simulate movement within the store. As items are placed in virtual shopping carts and the Web site visitors proceed to checkout screens, the associated icons within the analytics UI can be placed in queues within virtual checkout lines, to represent the process of completing purchases. Upon completion of a purchase, the visitor icons can be moved to positions outside of the floor plan (or deleted entirely). The net effect for the Web site administrator is one of watching customers browsing and making purchases within a physical store, allowing the Web site administrator to gain heretofore unavailable insight into actual Web site visitor behaviors.

In some embodiments of UIs configured in accordance with the present invention, real time information may be blended with historical information (captured over varying, perhaps user-selectable time periods) to provide means for comparing real time Web site visitor activities with historical visitor activities. In this way, the effects of certain marketing or advertising campaigns can be evaluated (and perhaps adjusted) on real time bases. Further, though the integration of real time communications channels, UIs configured in accordance with embodiments of the present invention can be used as tolls for directly influencing visitor behaviors (e.g., purchasing behaviors) in real time.

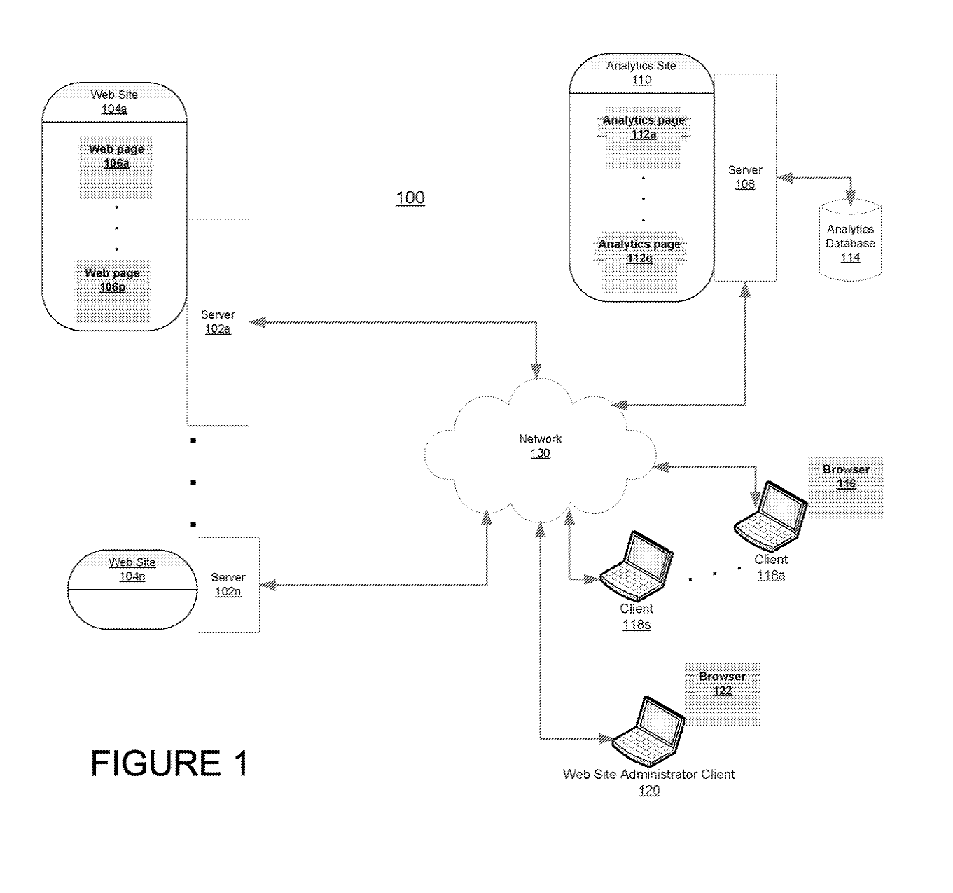

To better understand the context in which the present user interface may be employed, consider the network 100 illustrated in FIG. 1. Included in this network are various servers 102a-102n, each hosting one or more Web sites 104a-104n. Each Web site 104 may include one or more Web pages 106a-106p. As mentioned above, the Web sites may be commerce sites in which visitors are engaged in some sort of on-line commerce, but the present invention is not restricted to use in connection with such sites. Hence, the Web pages may be associated with social networking sites, forums, blogs, content sites, etc.

Also part of network 100 is a server 108, hosting an analytics site 110, which may be made up of a plurality of analytics pages 112a-112q. The analytics pages 112a-112q, some or all of which may comprise the present user interface, are the means by which analytics information concerning visits to Web sites 104a-104n is conveyed to Web site administrators. Such information may be stored by server 108 in an analytics database 114 that is communicatively coupled to server 108. In some cases, the analytics pages may be presented to a Web site administrator via a Web browser 122 running on a client computer system 120 as individual pages. Or, the analytics information may be presented via a single analytics dashboard, which itself is styled as one of the Web pages 112a-112q. Often, some combination of these presentation mechanisms will be employed concurrently and so the particular user interface pages and layouts to be discussed below should be regarded only as examples of possible configurations and are not intended to limit the present invention unnecessarily.

The Web sites 104a-104n are accessed by users via client systems 118a-118s. The client systems may, in some cases, be computer systems, such as personal computers or the like, but more generally may be any computer-based or processor-based device that executes application software which allows the content of the Web site to be rendered for display to the user on a display device. For example, client systems may include computer systems, mobile devices such as iPads™, smart phones, mobile phones, etc., and the application software may be a web browser 116 such as Microsoft Corporation's Internet Explorer™, Apple Inc.'s Safari™, or Google Inc.'s Chrome™, etc. Such applications are typically stored in one or more computer readable storage devices accessible to one or more processors of the subject client system and, when executed, cause the processor(s) to perform the operations necessary to render the subject sites/pages for display at the subject system (e.g., via a display device communicatively coupled to the processor). The various constituents of network 100 are communicatively coupled to one another via one or more computer/data networks 130, which may include the Internet and other networks coupled thereto. The precise nature of network 130 is not critical to the present invention.

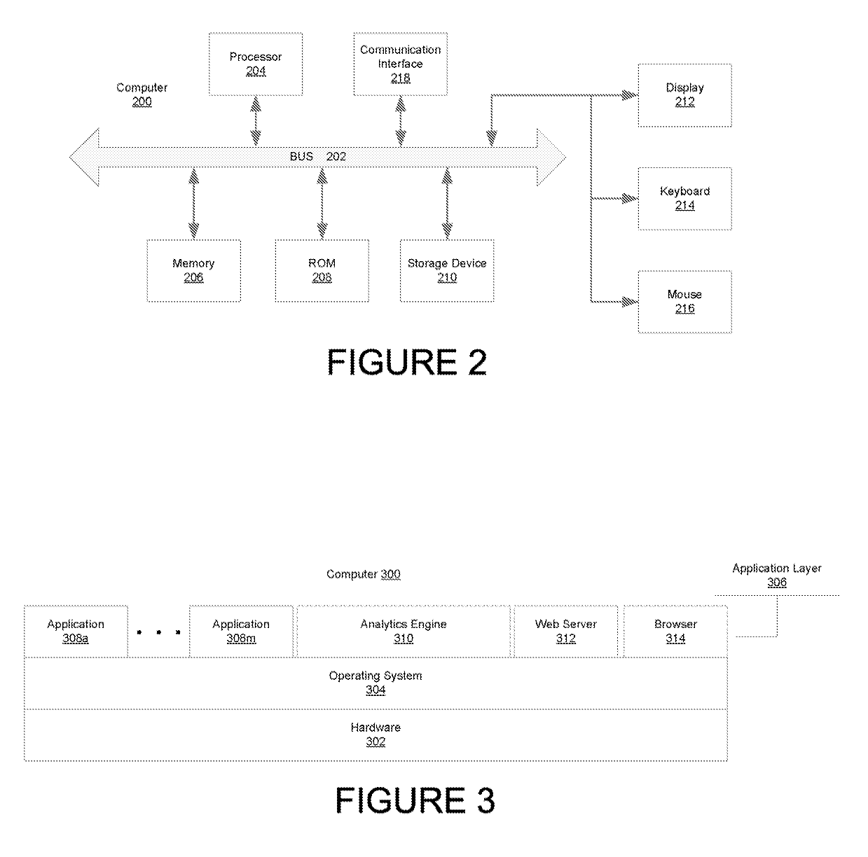

FIG. 2 illustrates a computer system 200. Computer system 200 may represent any of the computer systems discussed in connection with FIG. 1 and, in particular, may represent a server or other computer system upon which Web analytic applications which provide information via the user interfaces of the present invention may be instantiated. Computer system 200 includes a bus 202 or other communication mechanism for communicating information, and a processor 204 coupled with the bus 202 for processing information. Computer system 200 also includes a main memory 206, such as a RAM or other dynamic storage device, coupled to the bus 202 for storing information and instructions (such as instructions for producing the present user interfaces) to be executed by processor 204. Main memory 206 also may be used for storing temporary variables or other intermediate information during execution of instructions to be executed by processor 204. Computer system 200 further includes a ROM 208 or other static storage device coupled to the bus 202 for storing static information and instructions for the processor 204. A storage device 210, such as a hard disk, is provided and coupled to the bus 202 for storing information and instructions (such as instructions comprising the Web analytics application, Web server, and user interfaces discussed herein).

Computer system 200 may be coupled via the bus 202 to a display 212 for displaying information to a user, however, in the case of servers such a display may not be present and all administration of the server may be via remote clients. Likewise, input device 214, including alphanumeric and other keys, may be coupled to the bus 202 for communicating information and command selections to the processor 204, but such a device may not be present in server configurations. Another type of user input device is cursor control device 216, such as a mouse, a trackball, or cursor direction keys for communicating direction information and command selections to processor 204 and for controlling cursor movement on the display 212. Such an input device may or may not be present in a server configuration.

Computer system 200 also includes a communication interface 218 coupled to the bus 202. Communication interface 218 provides for two-way, wired and/or wireless data communication to/from computer system 200, for example, via a local area network (LAN) or other network. Communication interface 218 sends and receives electrical, electromagnetic or optical signals, which carry digital data streams representing various types of information. For example, two or more computer systems 200 may be networked together in a conventional manner with each using a respective communication interface 218.

The various databases described herein are computer-based record keeping systems. Stated differently, these databases are each a combination of computer hardware and software that acts together to allow for the storage and retrieval of information (data). Accordingly, they may resemble computer system 200, and are often characterized by having storage mediums capable of accommodating significant amounts of information.

FIG. 3 illustrates a computer system 300 from the point of view of its software architecture. With appropriate applications comprising a software application layer 306, computer system 300 may be server 108 referred to above, a client system 118, 120, or one of the Web servers 102 for a Web site 104.

The various hardware components of computer system 300 are represented as a hardware layer 302. An operating system 304 abstracts the hardware layer and acts as a host for various applications 308a-308m, that run on computer system 300. In the case of server 108, the operating system acts as a host for an analytics engine 310, which is configured to request and obtain the Web analytic information to be presented via the present user interface. For a server 102 and/or 108, the operating system may host a Web server application 312, which provides access for the client computers via Web browsers. In the case of a client system, the operating system acts as a host for a Web browser application 314.

As alluded to above, network 130 may include the Internet and the various servers and client computers communicatively coupled thereto may include computer systems, such as computer system 200, that are made up of one or more processors, associated memory (typically volatile and non-volatile) and other storage devices and peripherals that allow for connection to the Internet or other networks. The precise hardware configuration of the hosting and client resources is generally not critical to the present invention, nor are the precise algorithms used to implement the services and methods described herein. Instead, the focus is on the nature of the user interface provided in accordance with the present invention.

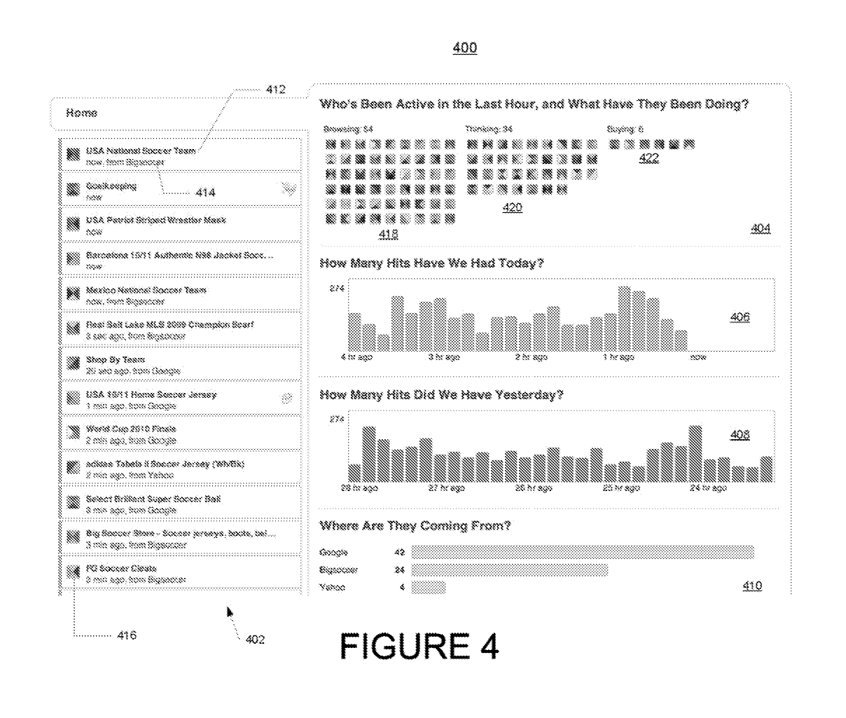

Turning now to FIG. 4, a first example of a user interface 400 adapted to allow a Web site owner/operator to view real time information concerning activities of visitors to the subject Web site is presented. User interface 400 may be delivered in the form of a Web page, such as analytics page 112a, by a server, such as server 108, to a Web site administrator client, such as client 120, and rendered on a display thereof in a Web browser, such as browser 122. Included in user interface 400 are various fields, including a visitor field 402, an activity field 404, and various history fields 406, 408, 410. Visitor field 402 includes, for each visitor to the subject Web site, identifying information of the visitor 412, which may be a visitor name or other identifying information received from the client 118 associated with the visitor to the subject web site, an indication of when the visitor is/was active on the subject Web site 414 (and in some cases this may include information identifying where the visitor arrived at the subject Web site from), and a jewel or other graphical element or icon 416.

The jewels 416 associated with the visitors are used in connection with the activity field 404 and may be grouped into various activity groups 418, 420, 422. Of course, these are merely examples of activity groups and in various embodiments, more or fewer activity groups may be used. In this example, activity group 418 identifies visitors to the site that are deemed to be “just browsing”. Activity group 420 identifies those users considered to be “thinking” about making purchases. Activity group 422 identifies those users who are actually “buying” products for sale at the subject Web site. The associated visitor jewels are placed in the various activity groups by the analytics server according to the actual visitor behavior at the subject Web site. For example, “browsing” users may be those who recently arrived at the site, and/or those who do not manifest significant dwell time on any particular product pages. Those users who do linger on particular product pages for at least a specified time interval may be classified as “thinking” about purchase decisions and so their associated jewels may be moved from the browsing activity group to the thinking activity group. For visitors that have actually placed products in a virtual shopping cart or otherwise manifest a purchasing decision or intent, their associated jewels may be moved into the buying activity group. Regardless of the classifications and/or number of activity groups, the important thing to notice is that the classifications of the various visitors to the subject Web site for which user interface 400 is providing analytical information is that the information is being delivered in real time to the Web site administrator and so is available for real time use by that administrator.

The information itself that is used to produce the analytical information may be derived from real time information collected by the analytics server 108 from the various visitor client machines 118. When a visitor first reaches the subject Web site with their browser, the Web site delivers a cookie to the browser. The cookie includes a script that causes the browser to report certain information to the analytics server, where the information is logged and stored in database 114. The stored information can then be analyzed to provide the real time feedback exemplified in user interface 400. The use of cookies allows for unique visitor identification and tracking even where IP addresses are shared by groups of users or proxies. Nevertheless, in alternative embodiments, JavaScript on each page of the subject Web site could be used to notify the analytics server when a page is rendered by a visitor's Web browser. Both methods collect data that can be processed to produce the information described herein.

The history fields may include a recent history field 406, a past history field 408 and a referral field 410. The recent history field 406 may include information regarding recent visitors to the subject Web site. For example, in the illustration shown in FIG. 4, the recent history field shows the number of visitors to the subject Web site during the present day in running periods of quarter-hours, with the data represented in a histogram. Of course, other representations and/or statistics regarding recent visitors may be presented in lieu of or in addition to this visitor number data.

The past history field 408 may include information regarding past visitors to the subject Web site. For example, in the illustration shown in FIG. 4, the past history field shows the number of visitors to the subject Web site over the past day or so in running periods of quarter-hours, with the data represented in a histogram. Of course, other representations and/or statistics regarding recent visitors may be presented in lieu of or in addition to this visitor number data.

The referral field 410 provides real time information concerning Web locations where visitors to the Web site are originating from. This may include referrals from search engine search result pages, from direct entries of Web site URLs into browser address fields, and/or other referral pages. By understanding where current visitors to the site are originating from, the Web site administrator is provided a powerful tool to direct current advertising and/or marketing resources in order to reach the greatest number of potential customers and/or to allocate limited funds.

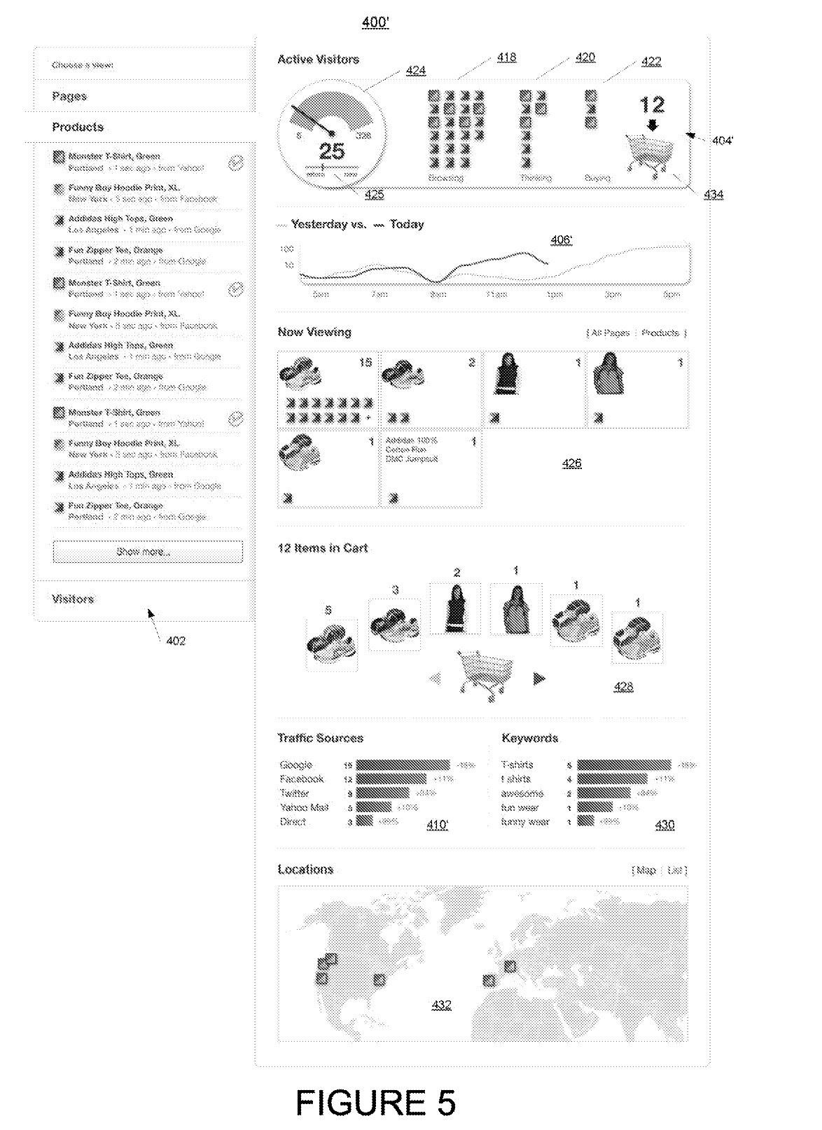

FIGS. 5-8 illustrate further examples of user interfaces adapted to allow a Web site owner/operator to view real time information concerning activities of visitors to the subject Web site. In FIG. 5, user interface 400′ includes the visitor field 402, with visitors associated with identifying jewels, and the various activity groups 418, 420, 422. In this example, however, the activity field 404′ includes additional items, including a gauge 424 that shows the number of current active visitors and an indication of the relative number of new visitors to the number of repeat visitors (see the slider 425 at the bottom of gauge 424). The gauge may be configured to flash or adopt other visual indications when new visitors arrive at the Web site and/or existing visitors leave the subject Web site. Also, the activity field 404′ includes a new shopping cart indicator 434 where, for a selected visitor, the number of items being purchased is represented as being present in the visitor's virtual shopping cart. The actual items so included in the shopping cart can be viewed in a purchasing field 428 elsewhere on the page. In this example, graphical representations representing the items being purchased (e.g., images of the products from the subject Web page) are shown as being included in the user's shopping cart and the administrator can scroll to see which items are so included in the cart.

Another new field in user interface 400′ is a product view field 426. In this field, real time information concerning which visitors are browsing which products is displayed. Notice that the jewels representing the visitors are arranged so as to be associated with the current product which the visitor is viewing in his/her Web browser. In addition, a total number of visitors viewing the subject product is provided.

The referral field 410′ again provides real time information concerning Web locations where visitors to the Web site are originating from and this time an associated keywords field 430 is provided as well. Keywords field 430 reports (e.g., using histograms, bar charts or other indicators) which keywords used in search engine queries are driving various numbers of visitors to the Subject Web site. This information can assist an administrator in making keyword purchase decisions. Further, a map 432 illustrates in a highly intuitive fashion where the current Web site visitors are originating from.

In this example, the history field 406′ has been organized as a graph showing relative numbers of visitors over selected time periods (e.g., yesterday vs. today). Of course, other visitor number informational display means could be used.

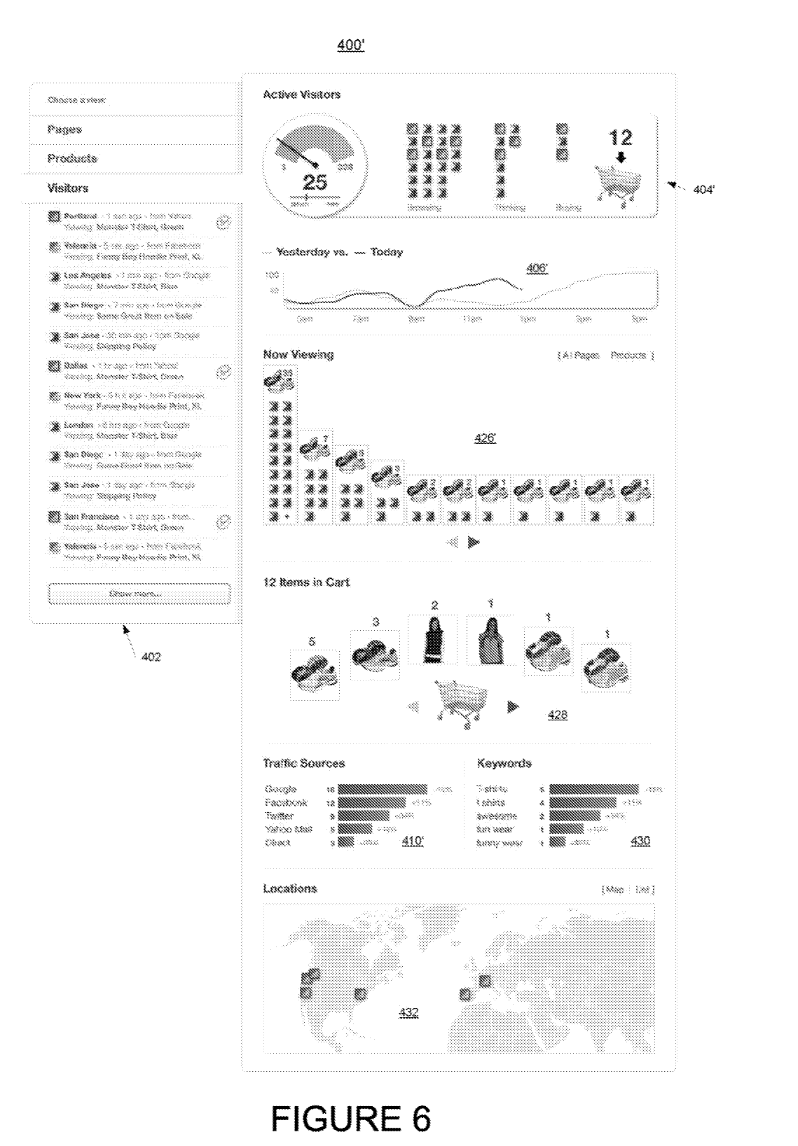

In FIG. 6, a modified product view field 426′ is included. In this representation, users are shown per page of the subject Web site, rather than per product as in FIG. 5. Page views, as opposed to product views may assist an administrator in understanding which pages are capturing the most user interest, for example if multiple pages are providing views of a common product.

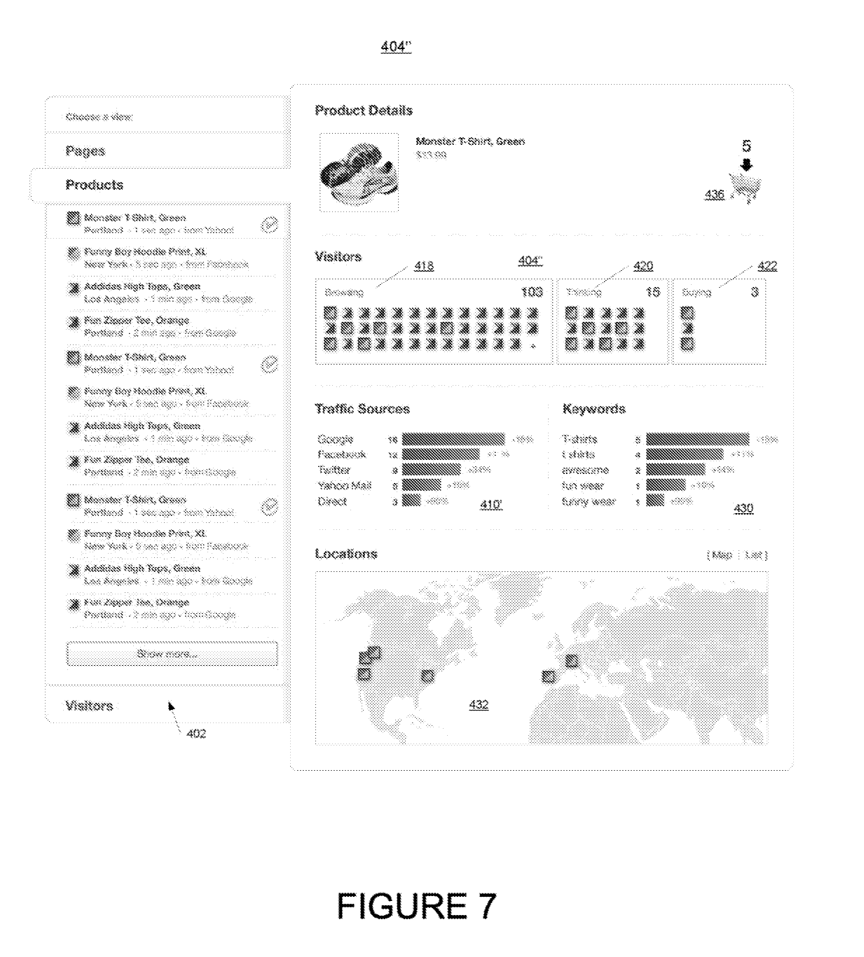

FIG. 7 illustrates yet a further example of a user interface 400″ adapted to allow a Web site owner/operator to view real time information concerning activities of visitors to the subject Web site. In this example, product detail field 436 provides information, on a product-by-product basis, concerning the number of visitors purchasing the subject product (e.g., as represented by the number of visitors that have placed the product in their respective shopping cart). Alternatively, the representation may concern the number of the subject products being purchased.

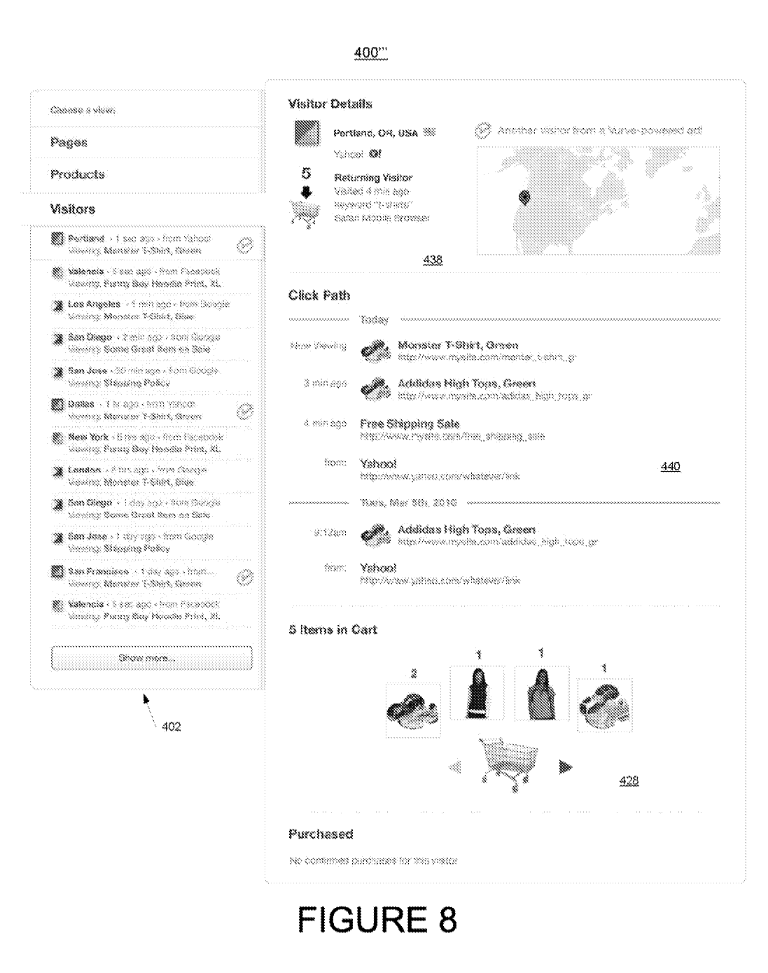

FIG. 8 illustrates yet another example of a user interface 400′″ adapted to allow a Web site owner/operator to view real time information concerning activities of visitors to the subject Web site. In this example, a user detail field 438 provides information concerning a specific visitor at the subject Web site. For example, the user's location, status (as a new or returning visitor), purchase history, referral source (and keyword search if one was used) may be presented. In addition, the user's browsing history may be presented in a click path field 440. Here, information concerning the actual browsing path followed by the user during a current session may be presented, including dwell times, mouse actions, etc.

Of course, many other informational representations may be provided in various configurations of the present user interface and the foregoing examples should not be read as limiting the present invention. In some instances, user classifications may be associated with the users, for example to indicate status as a loyal customer (e.g., one that makes frequent purchases), a discount customer (e.g., one that makes purchases only of sale items), an impulse buyer (e.g., one that adds items to shopping carts within a short period of time after arriving at the subject Web site), a needs-based buyer (e.g., one that arrived at the Web site though a specific keyword search and added the specified product to a shopping cart), and a wandering visitor (e.g., one that spent time viewing a number of different pages, but made no purchases).

As should be apparent from the foregoing discussion, various embodiments of the present invention may be implemented with the aid of computer-implemented processes or methods (i.e., computer programs or routines) or on any programmable or dedicated hardware implementing digital logic. Such processes may be rendered in any computer language including, without limitation, a object oriented programming language, assembly language, markup languages, and the like, as well as object-oriented environments such as the Common Object Request Broker Architecture (CORBA), Java™ and the like, or on any programmable logic hardware like CPLD, FPGA and the like.

It should also be appreciated that the portions of this detailed description that are presented in terms of computer-implemented processes and symbolic representations of operations on data within a computer memory are in fact the preferred means used by those skilled in the computer science arts to most effectively convey the substance of their work to others skilled in the art. In all instances, the processes performed by the computer system are those requiring physical manipulations of physical quantities. The computer-implemented processes are usually, though not necessarily, embodied the form of electrical or magnetic information (e.g., bits) that is stored (e.g., on computer-readable storage media), transferred (e.g., via wired or wireless communication links), combined, compared and otherwise manipulated. It has proven convenient at times, principally for reasons of common usage, to refer to these signals as bits, values, elements, symbols, keys, numbers or the like. It should be borne in mind, however, that all of these and similar terms are to be associated with the appropriate physical quantities and are merely convenient labels applied to these quantities.

Unless specifically stated otherwise, it should be appreciated that the use of terms such as processing, computing, calculating, determining, displaying or the like, refer to the action and processes of a computer system, or similar electronic computing device, that manipulates and transforms data represented as physical (electronic) quantities within the computer system's registers, memories and other storage media into other data similarly represented as physical quantities within the computer system memories, registers or other storage media. Embodiments of the present invention can be implemented with apparatus to perform the operations described herein. Such apparatus may be specially constructed for the required purposes, or may be appropriately programmed, or selectively activated or reconfigured by a computer-readable instructions stored in or on computer-readable storage media (such as, but not limited to, any type of disk including floppy disks, optical disks, hard disks, CD-ROMs, and magnetic-optical disks, or read-only memories (ROMs), random access memories (RAMs), erasable ROMs (EPROMs), electrically erasable ROMs (EEPROMs), magnetic or optical cards, or any type of media suitable for storing computer-readable instructions) to perform the operations. Of course, the processes presented herein are not restricted to implementation through computer-readable instructions and can be implemented in appropriate circuitry, such as that instantiated in an application specific integrated circuit (ASIC), a programmed field programmable gate array (FPGA), or the like.

It should be appreciated that the embodiments described above are cited by way of example, and that the present invention is not limited to what has been particularly shown and described hereinabove. Rather, the present invention includes both combinations and subcombinations of the various features described hereinabove, as well as variations and modifications thereof which would occur to persons skilled in the art upon reading the foregoing description and which are not disclosed in the prior art.

What is claimed is:

1. A computer system, comprising a processor and a storage device, said storage device storing instructions which, when executed by the processor, cause the processor to deliver a user interface (UI) for presentation of analytics information to second computer system, said UI including a plurality of information fields which provide real time information concerning visitor browsing and purchasing activities at a subject Web site with which the analytics information is concerned, the information organized as some or all of: visitor purchasing behavior as grouped by proximity to completing a purchase, visitor visit history, product-based visitor viewing history, visitor referral path, visitor keyword search history, visitor click path, and visitor location.

2. The computer system of claim 1, wherein the UI is presented as a web page at the second computer system.

3. The computer system of claim 1, wherein the UI facilitates interaction between an operator of the subject Web site with which the analytics information is concerned and a visitor to said subject Web site.

4. The computer system of claim 1, wherein the information comprises, at least in part, graphical representations of site visitors, characterized by one or more of: activity, Web page, product or service, location, referring source, and referring mechanism.

5. The computer system of claim 1, wherein the UI comprises, at least in part, an animated floor plan in which a virtual store is represented by a virtual floor plan with products offered by the store arranged in virtual departments or shelves, and visitors to the Web site are represented as graphical icons within the virtual store floor plan.

6. The computer system of claim 1, wherein the UI includes both the real time information and historical information concerning visitors' past visits to the Web site.

7. The computer system of claim 1, wherein included in the UI is a visitor field, which includes, for each visitor to the subject Web site, identifying information of the visitor, an indication of when the visitor is/was active on the subject Web site, and a jewel or other graphical element or icon.

8. The computer system of claim 7, wherein jewels associated with the visitors are grouped into various activity groups according to shopping behaviors of the associated visitors.

9. The computer system of claim 1, wherein information used to produce the analytics information is derived through use of a cookie delivered to a browser running on the second computer system.

10. The computer system of claim 1, wherein information used to produce the analytics information is derived through use of computer-executable instructions on each page of the subject Web site.

11. The computer system of claim 1, wherein the visitor visit history is organized as one or more of: history, for information regarding recent visitors to the subject Web site, and referrals, for information concerning Web locations where visitors to the subject Web site are originating from.

12. The computer system of claim 1, wherein the UI includes a product view field comprising real time information concerning which visitors are browsing which products.

13. The computer system of claim 1, wherein the UI includes a product detail field that provides information, on a product-by-product basis, concerning a number of visitors purchasing a subject product.

14. A method, comprising, presenting, via a computer system, a user interface (UI) which includes, at least in part, an animated floor plan in which a virtual store is represented by a virtual floor plan with products offered by the store arranged in virtual departments or shelves, and visitors to a Web site are represented as graphical icons within the virtual store floor plan, and updating the UI so that as the visitors browse the Web site represented by the virtual store, their associated icons are moved to corresponding positions within the virtual floor plan to simulate movement within the store.

15. The method of claim 14, wherein as visitors place items within associated virtual shopping carts and proceed to checkout screens of the Web site, the UI is updated so that visitors' associated icons are placed in queues within virtual checkout lines, to represent the process of completing purchases.

16. The method of claim 15, wherein upon completion of a purchase, the UI is updated so that an associated visitor's icon is moved to a position outside of the virtual floor plan or deleted entirely.
